(19) United States
(12) Patent Application Publication
(10) Pub. No.: US 2009/0041934 A1
(43) Pub. Date: Feb. 12, 2009

(54) METHOD FOR MANUFACTURING PROJECTION OPTICS

(75) Inventor: Takumi Tokimitsu, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/182,054

(22) Filed: Jul. 29, 2008

(30) Foreign Application Priority Data
Aug. 7, 2007 (JP) 2007-205181

(51) Int. Cl. B05D 5/06

(52) U.S. Cl. 427/163.1

(57) ABSTRACT

A method for manufacturing a projection optics that includes a plurality of optical elements composed of an amorphous material is provided. The method includes preparing a plurality of optical-thin-film candidates having various transmission characteristics, measuring transmission characteristics of the plurality of optical elements, calculating a transmission characteristic of the projection optics supposing that a certain optical-thin-film candidate of the plurality of optical-thin-film candidates is formed on a surface of each of the optical elements, selecting an optical thin film to be formed on the surface of each of the optical elements from the plurality of optical-thin-film candidates based on the calculated transmission characteristic, and forming the selected optical thin film on the surface of each of the optical elements.

### BACKGROUND OF THE INVENTION

1. Field of the Invention

The present invention relates to a method for manufacturing a projection optics (projection optical system) equipped in an exposure apparatus used for exposing a photosensitive substrate to light.

2. Description of the Related Art

Generally, reduction projection exposure apparatuses are used for manufacturing fine semiconductor devices or liquid crystal display devices, such as semiconductor memory chips or logic circuits, by photolithography. In a typical reduction projection exposure apparatus, a circuit pattern drawn on a reticle or a mask (original) is projected onto, for example, a wafer (substrate) through a projection optics so as to transfer the circuit pattern onto the wafer.

A minimum critical dimension (resolution) transferrable in a reduction projection exposure apparatus is proportional to the wavelength of light used for the exposure process, and is inversely proportional to the numerical aperture (NA) of the projection optics. Therefore, the shorter the wavelength and the higher the numerical aperture, the better the resolution. With the miniaturization of semiconductor devices in recent years, the ability to achieve smaller resolution values is in great demand. Accordingly, the resolution is expected to be enhanced by shortening the wavelength of exposure light and increasing the numerical aperture of the projection optics.

On the other hand, light sources used in exposure apparatuses have been changed from a KrF laser (with a wavelength of 248 nm) to an ArF laser (with a wavelength of 193 nm) in accordance with the shortening of the wavelength.

Under these circumstances, synthetic quartz and fluoride crystal material are mainly used for transparent members contained in a projection optics that utilizes exposure light with a wavelength below 250 nm. Such transparent members need to have extremely low birefringence to achieve high optical performance.

A birefringence in a transparent member can be roughly classified into two kinds: intrinsic birefringence caused due to crystalline orientation of the transparent member and stress birefringence caused by internal stress of the transparent member. Fluorite, which is a type of a fluoride crystal material, has intrinsic birefringence that is not negligible in terms of optical performance.

On the other hand, an amorphous material such as synthetic quartz substantially does not have intrinsic birefringence caused due to crystalline orientation. However, synthetic quartz has stress birefringence conceivably caused by impurities and thermal stress, and the amount of such stress birefringence can have a non-negligible effect on the imaging performance of the projection optics.

An example of a method for manufacturing high quality synthetic quartz glass for exposure apparatuses is disclosed in Japanese Patent Laid-Open No. 2000-331927. Synthetic quartz glass can be manufactured using a direct method, a vapor axial deposition (VAD) method, a sol-gel method, a plasma burner method, etc.

However, in either of these methods, when the synthetic quartz formed under high temperature is being cooled down, stress is generated due to differences in the way the surface and the core of the synthetic quartz are cooled. In other words, stress caused by thermal hysteresis is generated. Although such stress caused by thermal hysteresis can be alleviated to some extent by heating, such as by annealing, it is basically difficult to reduce the stress to zero. Since optical elements included in a projection optics are circular and axisymmetrical, the synthetic quartz is formed into a columnar shape and is annealed in this shape. Therefore, the fast axis of birefringence is axisymmetrical and the amount of birefringence is mostly occupied by rotation-symmetrical components.

With the higher numerical aperture in projection optics, the incident angle of light beams on the boundary surfaces (surfaces) of the optical elements is increased. This makes it progressively more difficult to make uniform the reflectance or transmittance with respect to all of the incident angles on reflection films or antireflection films. For example, if an antireflection film is to be formed over the surface of synthetic quartz, the antireflection film can be formed with an optical-thin-film material normally used for vacuum-ultraviolet light with a wavelength of 193 nm and containing fluoride or oxide component. However, when forming an antireflection film using such an optical-thin-film material, if the maximum incident angle of light is high, at least one of the reflectance of P-polarized light and the reflectance of S-polarized light would unfavorably exceed 1% particularly with respect to a surface having a maximum incident angle of 55° or higher. On the other hand, in a high numerical aperture projection optics in which the numerical aperture exceeds 0.85, a light beam passing through a peripheral region in the pupil plane would generally enter a boundary surface of an optical element at an incident angle higher than 55°.

Therefore, in a high numerical aperture projection optics with a numerical aperture exceeding 0.85, the intensity of a light beam passing through the peripheral region in the pupil plane will inevitably be a value different from that of the intensity of a light beam passing through the core of the system. The intensity distribution of a light beam passing through an arbitrary image height within the pupil plane will simply be referred to as a “pupil intensity distribution” hereinafter.

When a projection optics has varied pupil intensity distributions within a screen (exposure area), an optical proximity effect (OPE) undesirably varies within the screen. The OPE causes patterns having the same dimensions on the reticle to be exposed onto the wafer as patterns having different dimensions.

A technique for correcting the OPE by adjusting the patterns on the reticle is called an optical proximity correction (OPC). Normally, an OPC is performed evenly within the screen of the projection optics. When the OPE varies within the screen, the patterns within the screen unfavorably vary in dimensions due to the OPE. A reticle having undergone an OPC is not only used for a single exposure apparatus, but may be also used in other exposure apparatuses. Therefore, the projection optics must be manufactured such that there is no individual difference in the pupil intensity distribution and that the pupil intensity distribution be set to a desired state, e.g. a desired pupil intensity distribution calculated in the designing stage of the projection optics. In addition, the projection optics must be manufactured such that the pupil intensity distribution is uniform within the screen.

However, as mentioned above, a projection optics with a high numerical aperture has optical elements with a high incident angle of light. In addition, the reflectance in a high incident angle region of an antireflection film is extremely susceptible to a manufacture error in the antireflection film. Therefore, it is difficult to make uniform the pupil intensity distribution within the screen in a projection optics with a high numerical aperture.

Because the pupil intensity distribution unfavorably changes even when the internal transmittance of a transparent member becomes non-uniform due to a manufacture error, it is even more difficult to set the pupil intensity distribution of a high numerical aperture projection optics to a desired value uniformly within the screen. The term “internal transmittance” refers to the transmittance of light passing through the interior of a transparent member without taking into account the reflection of the light at the surface of the transparent member.

Although it is realistically difficult to reduce the birefringence of a transparent member to zero, a projection optics having polarization characteristics that allow for substantially no phase difference between two orthogonal polarized light beams is necessary.

### SUMMARY OF THE INVENTION

The present invention provides a method for stably manufacturing a projection optics having a desired pupil intensity distribution and desired polarization characteristics.

According to an aspect of the present invention, a method for manufacturing a projection optics that includes a plurality of optical elements composed of an amorphous material is provided. The method includes preparing a plurality of optical-thin-film candidates having various transmission characteristics, measuring transmission characteristics of the plurality of optical elements, calculating a transmission characteristic of the projection optics supposing that a certain optical-thin-film candidate of the plurality of optical-thin-film candidates is formed on a surface of each of the optical elements, selecting an optical thin film to be formed on the surface of each of the optical elements from the plurality of optical-thin-film candidates based on the calculated transmission characteristic, and forming the selected optical thin film on the surface of each of the optical elements.

Further features of the present invention will become apparent from the following description of exemplary embodiments with reference to the attached drawings.

### BRIEF DESCRIPTION OF THE DRAWINGS

FIG. 1 illustrates a projection optics according to a first embodiment of the present invention.

FIG. 2 is a flow chart showing a method for manufacturing the projection optics according to the first embodiment.

FIG. 3 is a graph showing the incident-angle dependence with respect to the transmittance of S-polarized light in optical thin films A, B, and C having film designs A, B, and C in Table 1.

FIG. 4 is a graph showing the incident-angle dependence with respect to the transmittance of P-polarized light in the optical thin films A, B, and C having the film designs A, B, and C in Table 1.

FIG. 5 is a graph showing the incident-angle dependence with respect to a phase difference between P-polarized light and S-polarized light in the optical thin films A, B, and C having the film designs A, B, and C in Table 1.

FIG. 6 is a graph showing the incident-angle dependence with respect to the transmittance of S-polarized light in optical thin films A, D, and E having film designs A, D, and E in Table 1.

FIG. 7 is a graph showing the incident-angle dependence with respect to the transmittance of P-polarized light in the optical thin films A, D, and E having the film designs A, D, and E in Table 1.

FIG. 8 is a graph showing the incident-angle dependence with respect to a phase difference between P-polarized light and S-polarized light in the optical thin films A, D, and E having the film designs A, D, and E in Table 1.

FIG. 9 is a flow chart of a method for manufacturing a projection optics according to a second embodiment of the present invention.

FIG. 10 is a flow chart of a method for manufacturing a projection optics according to a third embodiment of the present invention.

### DESCRIPTION OF THE EMBODIMENTS

Various embodiments of the present invention will now be described with reference to the attached drawings.

### First Embodiment

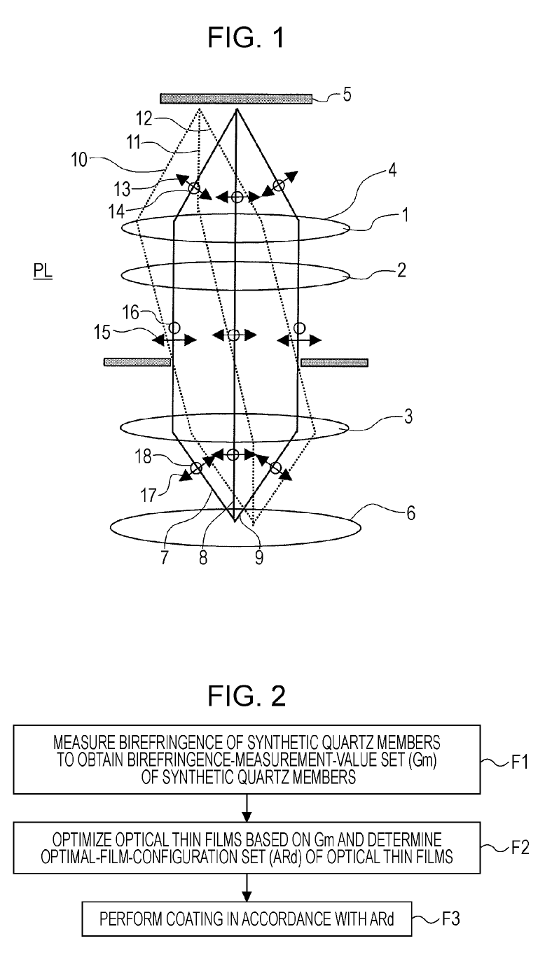

FIG. 1 illustrates a projection optics PL according to a first embodiment of the present invention. The projection optics PL according to the first embodiment is applicable to a step-and-repeat exposure apparatus or to a step-and-scan exposure apparatus. The projection optics PL includes several tens of optical elements and is configured such that the aberrations are corrected with high accuracy. In FIG. 1, these several tens of optical elements are simplified such that only lenses 1 to 3 are shown as representative optical elements. The optical elements are composed of amorphous synthetic quartz.

The lenses 1 to 3 are formed by cutting and polishing a synthetic quartz material. Reference numeral 4 denotes an optical thin film formed over a boundary surface of each lens. An optical thin film used for ultraviolet light may be made of a low refractive index material, a high refractive index material, or a high reflectance material. A low refractive index material is generally composed of magnesium fluoride (MgF₂), whereas a high refractive index material is generally composed of lanthanum fluoride (LaF₃), neodymium fluoride (NdF₃), gadolinium fluoride (GdF₃), or samarium fluoride (SmF₃). A high reflectance material is generally composed of aluminum (Al) or silver (Ag).

In FIG. 1, reference numeral 5 denotes a reticle, and reference numeral 6 denotes a wafer. Reference numerals 7 to 9 indicate representative light beams that travel on a light axis between the reticle 5 and the wafer 6, whereas reference numerals 10 to 12 indicate representative light beams that travel off-axis. The projection optics PL according to the first embodiment is a telecentric optical system in which the light beams 8 and 11 are principal light beams that are parallel to the light axis.

To explain the polarization characteristics of the projection optics PL in FIG. 1, polarized components are illustrated with respect to each of the light beams 7 to 9. In particular, polarized components of the light beam 7 before entering the lens 1 are indicated by reference numerals 13 and 14, polarized components of the light beam 7 after exiting the lens 2 are indicated by reference numerals 15 and 16, and polarized components of the light beam 7 after exiting the lens 3 are indicated by reference numerals 17 and 18. The polarized components 13, 15, and 17 are parallel to the plane of the drawing, whereas the polarized components 14, 16, and 18 are orthogonal to the plane of the drawing. As shown in FIG. 1, before the light beam 7 enters the lens 1, the polarized components 13 and 14 have the same wavefront. As the light beam 7 passes through the two transparent members, i.e. the lenses 1 and 2, the wavefronts of the polarized components 15 and 16 deviate from each other, that is, a phase difference occurs between the two polarized components 15 and 16 that are orthogonal to each other (two-polarized-light phase difference). This phase difference occurs due to a stress birefringence inside the lenses and also due to a two-polarized-light phase difference in the optical thin films formed over the lens surfaces. If a light beam in the state of two-polarized-light phase difference reaches the wafer 6, the imaging performance of the projection optics PL can deteriorate.

When the light beams 7 to 9 are to be emitted from one point of the reticle 5 through the projection optics PL, the intensities of the light beams 7 to 9 on the reticle 5 become attenuated to different intensities as the light beams 7 to 9 reach one point of the wafer 6. The attenuation of the intensities occurs due to the transmittance at the lens boundary surfaces and the transmittance in the interior of the lenses, and the amount of attenuation varies among the light beams due to different incident angles and incident positions of the light beams with respect to the lens boundary surfaces and also due to different transmission distances through the interior of the lenses. Therefore, unless these differences are taken into account, the intensity distribution at the pupil plane of the light beams emitted from one point of the reticle 5, i.e. pupil intensity distribution, cannot be made uniform.

In addition, the pupil intensity distribution varies depending on the polarized state of the incident light beams. This is mainly because the transmittance and reflectance at the optical thin films vary depending on the direction of polarization of the incident light beams.

FIG. 2 is a flow chart showing a method for manufacturing the projection optics PL according to the first embodiment for solving the aforementioned problems. The manufacturing method according to the first embodiment includes a measurement step F1 for measuring a stress birefringence distribution of synthetic quartz, and an optimization step F2 for optimizing the optical thin films. The manufacturing method further includes a coating step F3 for forming the optimized optical thin films on the lenses.

In step F1, the birefringence of each of synthetic quartz members is measured. A set of birefringence measurement values of the synthetic quartz members obtained from this measurement result will be defined as Gm for convenience. The set Gm contains a birefringence amount distribution and a fast-axis distribution of birefringence in each synthetic quartz member. Step F1 may either be performed before or after the shaping of the synthetic quartz members. In other words, the birefringence measurement may either be performed in the state where the synthetic quartz members are in the form of actual lenses or in the form of a preprocessed state, such as when the synthetic quartz members are still in the form of disks or blocks.

In step F2, the optical thin films are optimized such that the pupil intensity distribution and the two-polarized-light phase difference in the projection optics PL determined on the basis of Gm are optimized. In detail, the optical thin films are optimized such that the two-polarized-light phase difference is reduced and the pupil intensity distribution is made uniform within a screen. In this optimization step, film designs A to E shown below in Table 1 are used as a set of candidate designs for the optical thin films to be formed over the boundary surfaces of the synthetic quartz members.

TABLE 1

| | | FILM THICKNESS (nm) | | | | |
|---|---|---|---|---|---|---|
| FILM | REFRACTIVE | FILM | FILM | FILM | FILM | FILM |
| TYPE | INDEX | DESIGN A | DESIGN B | DESIGN C | DESIGN D | DESIGN E |
| L | 1.40 | 26.69 | 31.00 | 31.56 | 24.35 | 37.70 |
| H | 1.70 | 14.08 | 17.63 | 9.71 | 16.85 | 10.88 |
| L | 1.40 | 10.02 | 14.93 | 21.63 | 19.43 | 10.00 |
| H | 1.70 | 46.43 | 22.87 | 30.32 | 25.47 | 41.92 |
| L | 1.40 | 14.12 | 41.08 | 13.15 | 20.32 | 23.38 |
| H | 1.70 | 43.56 | 46.16 | 46.78 | 46.10 | 47.21 |
| L | 1.40 | 34.03 | 27.53 | 33.70 | 34.22 | 27.37 |

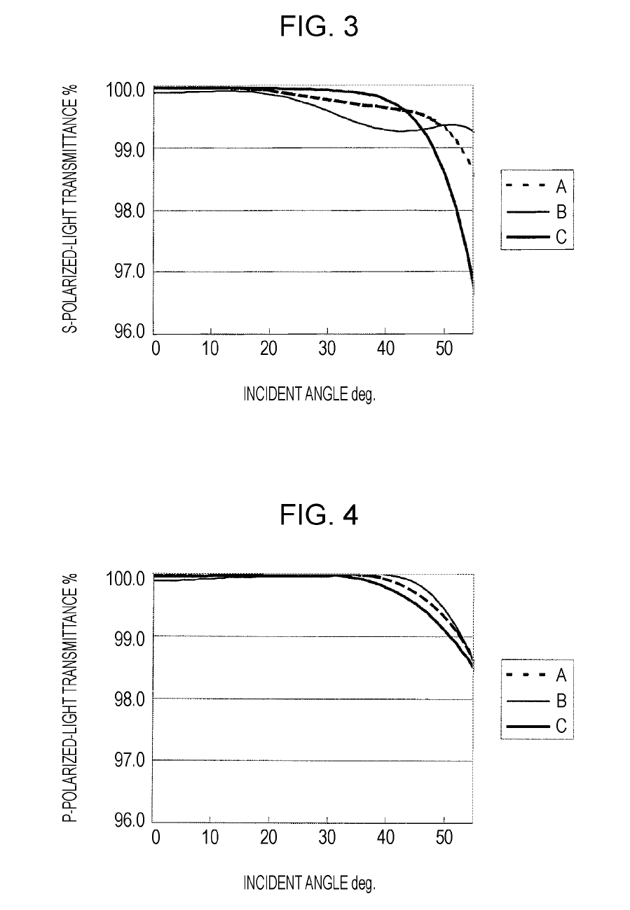

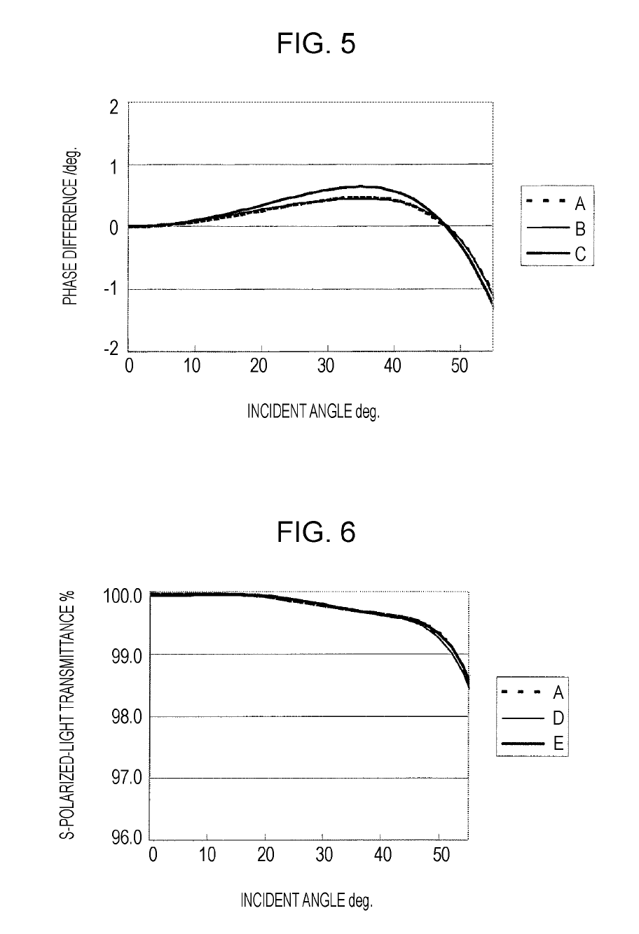

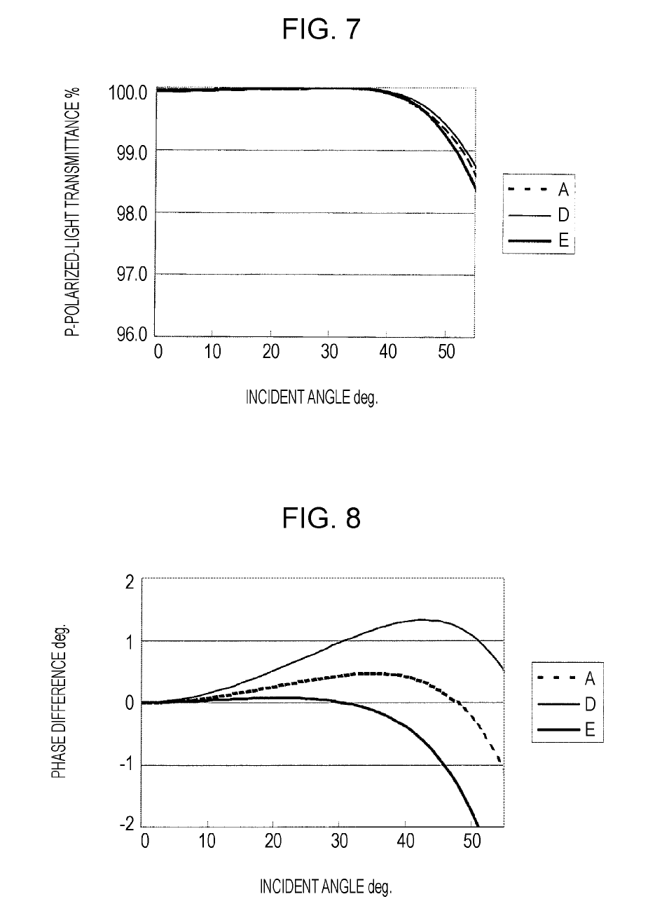

The film designs A to E are film designs for antireflection films (optical thin films) with respect to a wavelength of 193 nm. FIG. 3 illustrates the incident-angle dependence with respect to the transmittance of S-polarized light in optical thin films A, B, and C. FIG. 4 illustrates the incident-angle dependence with respect to the transmittance of P-polarized light in the optical thin films A, B, and C. FIG. 5 illustrates the incident-angle dependence with respect to a phase difference between P-polarized light and S-polarized light in the optical thin films A, B, and C. FIG. 6 illustrates the incident-angle dependence with respect to the transmittance of S-polarized light in optical thin films A, D, and E. FIG. 7 illustrates the incident-angle dependence with respect to the transmittance of P-polarized light in the optical thin films A, D, and E. FIG. 8 illustrates the incident-angle dependence with respect to a phase difference between P-polarized light and S-polarized light in the optical thin films A, D, and E. The characteristics of the optical thin film A are such that the S-polarized-light transmittance and the P-polarized-light transmittance are both 98.5% or higher when the incident angle is in a range below or equal to 55°, and that the P-S phase difference Δ is about 10 or less when the incident angle is in the range below or equal to 55°.

By forming the optical thin films B and C having the film designs B and C over the boundary surfaces of the optical elements, the incident-angle characteristics (i.e. the incident-angle dependence) with respect to the transmittance at the surfaces of the optical elements can be varied relative to that obtained with the film design A. Likewise, by forming the optical thin films D and E having the film designs D and E over the boundary surfaces of the optical elements, the incident-angle characteristics with respect to the phase difference at the surfaces of the optical elements can be varied relative to that obtained with the film design A. Regarding the film designs A, B, and C with the varied incident-angle characteristics with respect to transmittance, there is little to no variation in the incident-angle characteristics with respect to phase difference. On the other hand, regarding the film designs A, D, and E having the varied incident-angle characteristics with respect to phase difference, there is little to no variation in the incident-angle characteristics with respect to transmittance. This implies that the pupil intensity and the two-polarized-light phase difference can be controlled independent of each other.

This optimization is implemented by selecting appropriate film designs from the film designs A to E with respect to the boundary surfaces of the optical elements, calculating the phase difference in the projection optics and the pupil intensity distribution at each image height within a screen, and then repeating these selection and calculation processes. The calculation process can be performed by using light-beam tracking data of the projection optics PL according to the first embodiment, the incident-angle characteristics of the optical thin films, and Gm. In the first embodiment, the optimization is performed by preparing film designs for the optical thin films in advance, and then selecting appropriate film designs. Of the calculation results obtained in the above-described manner, a combination of film designs A to E with respect to the boundary surfaces of the optical elements that exhibits the best result becomes the optimization result. An optimal combination of film designs will be referred to as ARd hereinafter.

Regarding this optimization, the more film designs that are prepared, the better the optimization result that can be obtained. Moreover, an even better optimization result can be obtained by adjusting the film designs with respect to arbitrary boundary surfaces such that the film thickness of all of the films finely varies from each other by about ±10%, or such that the film thickness of only a portion of the films, instead of all of the films, finely varies from each other by about ±10%.

Finally, in step F3, the boundary surface of each optical element is coated with an optical thin film in accordance with ARd.

### Second Embodiment

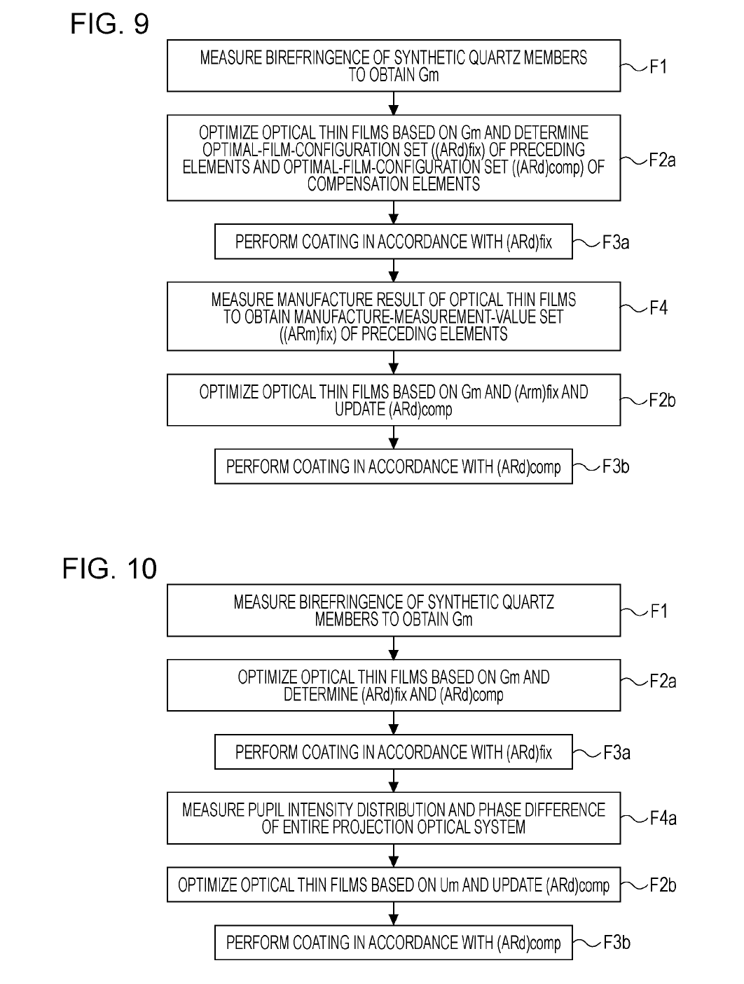

FIG. 9 is a flow chart of a method for manufacturing a projection optics according to a second embodiment of the present invention. Similar to the first embodiment, the manufacturing method according to the second embodiment includes a measurement step F1 for measuring a stress birefringence distribution of synthetic quartz, and an optimization step F2a for optimizing the optical thin films. In the second embodiment, the coating step of the optical thin films is divided into two steps, i.e. step F3a and step F3b. The manufacturing method according to the second embodiment also includes step F4 for measuring the coating result obtained in step F3a. To describe this in more detail, a manufacture error (manufacture result value) in the first coating step F3a is measured in step F4, and an optimization (reselection) process is performed again in step F2b based on the measurement result, whereby the measurement result and the optimization result can be used as feedback for the second coating step F3b. In the description below, an optical element to be given a coating treatment in the first coating step F3a will be referred to as a preceding element, and an optical element to be given a coating treatment in the second coating step F3b will be referred to as a compensation element.

The optimization step F2a is based on Gm like step F2 in the first embodiment, but in step F2a a combination (ARd)fix of optimal film designs with respect to the boundary surfaces of preceding elements and a combination (ARd)comp of optimal film designs with respect to the boundary surfaces of compensation elements is obtained. In step F3a, the coating process is performed only on the preceding elements in accordance with (ARd)fix. Subsequently, in step F4, a coating result from step F3a is measured. The measurement in step F4 is performed based on, for example, the incident-angle dependence with respect to transmittance at the boundary surfaces of the preceding elements, spectral characteristics, and the incident-angle dependence with respect to P-S phase difference (two-polarized-light phase difference). With this measurement, it is determined what kind of error exists in the actual coating result relative to (ARd)fix. A set of coating results (manufacture result values) for the boundary surfaces of the preceding elements obtained in this manner will be referred to as (ARm)fix hereinafter.

Subsequently, the optical thin films are optimized again in step F2b. Since (ARm)fix is already obtained and the thin film configuration for the preceding elements is fixed, the optimization is performed only for the remaining compensation elements, whereby (ARd)comp is updated. The optimization process in this case is the same as that in step F2a. In step F3b, the coating process is performed only on the compensation elements in accordance with the updated (ARd)comp.

Although the optical elements are sorted into two groups of elements, i.e. preceding elements and compensation elements, in the second embodiment, the optical elements may alternatively be sorted into three or more groups of elements. In that case, the number of feedback processes to be performed with respect to coating errors can be increased.

### Third Embodiment

FIG. 10 is a flow chart of a method for manufacturing a projection optics according to a third embodiment of the present invention. Similar to the second embodiment, the manufacturing method according to the third embodiment includes a measurement step F1 for measuring a stress birefringence distribution of synthetic quartz, an optimization step F2a for optimizing the optical thin films, a coating step F3a for the preceding elements, a coating step F3b for the compensation elements, and a measurement step F4a for measuring the phase difference (manufacture result values) and the pupil intensity distribution in the projection optics. A measurement value Um of the projection optics in step F4a is affected by a stress birefringence caused by external stress of synthetic quartz, in addition to the effects of Gm and (Arm)fix. In the third embodiment, the optimization step F2b is performed by using this measurement value Um as an indicator.

Regarding the method for manufacturing the projection optics according to the third embodiment where the aberrations are corrected with high accuracy, the method can additionally include an aberration correcting step. Specifically, this aberration correcting step includes measuring the aberrations in the projection optics and performing additional slight processing (additional polishing) on the surfaces of the plurality of optical elements using the obtained measurement result as an indicator. In the third embodiment, to increase the efficiency of manufacture, it is preferable that the aberration measurement in this aberration correcting step and step F2b be performed at the same time. When performing additional processing on the surfaces of the optical elements to correct the aberrations, the optical thin films are formed over the surfaces of the optical elements after the completion of the additional processing. Accordingly, in the third embodiment, to increase the efficiency of manufacture, it is preferable that the optical elements subjected to additional processing correspond to the compensation elements.

### Device Manufacturing Method According to Exemplary Embodiment

A device such as a semiconductor device or a liquid crystal display device can be manufactured by performing the following steps: a step for performing an exposure process on a substrate, such as a single-crystal substrate or a glass substrate, coated with a sensitizer by using an exposure apparatus equipped with a projection optics manufactured in accordance with any of the above described embodiments of method for manufacturing a projection optics, a step for performing a development process on the substrate, and known additional steps.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2007-205181 filed Aug. 7, 2007, which is hereby incorporated by reference herein in its entirety.

What is claimed is:

1. A method for manufacturing a projection optics that includes a plurality of optical elements composed of an amorphous material, the method comprising:
preparing a plurality of optical-thin-film candidates having various transmission characteristics;
measuring transmission characteristics of the plurality of optical elements;
calculating a transmission characteristic of the projection optics supposing that a certain optical-thin-film candidate of the plurality of optical-thin-film candidates is formed on a surface of each of the optical elements;
selecting an optical thin film to be formed on the surface of each of the optical elements from the plurality of optical-thin-film candidates based on the calculated transmission characteristic; and
forming the selected optical thin film on the surface of each of the optical elements.

2. A method for manufacturing a projection optics that includes a plurality of optical elements composed of an amorphous material, the method comprising:
preparing a plurality of optical-thin-film candidates having various transmission characteristics;
measuring transmission characteristics of the plurality of optical elements;
calculating a transmission characteristic of the projection optics supposing that a certain optical-thin-film candidate of the plurality of optical-thin-film candidates is formed on a surface of each of the optical elements;
selecting an optical thin film to be formed on the surface of each of the optical elements from the plurality of optical-thin-film candidates based on the calculated transmission characteristic;
forming the selected optical thin film on the surface of at least one optical element of the plurality of optical elements;
measuring a manufacture result value of the optical thin film formed on the surface of the at least one optical element;
selecting an optical thin film to be formed on the surface of the remaining one or more optical elements included in the plurality of optical elements from the plurality of optical-thin-film candidates based on the measured manufacture result value; and
forming the optical thin film to be formed on the surface of the remaining one or more optical elements.

3. The method according to claim 2, wherein the measured manufacture result value comprises a transmission characteristic of the at least one optical element having the optical thin film formed thereon.

4. The method according to claim 2, wherein the measured manufacture result value comprises the transmission characteristic of the projection optics including the at least one optical element having the optical thin film formed thereon.

5. The method according to claim 1, wherein the transmission characteristics measured for the plurality of optical elements comprise at least one of a birefringence distribution and internal transmittance of the plurality of optical elements,
wherein the transmission characteristic calculated for the projection optics comprises at least one of a two-polarized-light phase difference between two polarized light beams and a pupil intensity distribution in the projection optics, and
wherein a transmission characteristic present among the plurality of optical-thin-film candidates comprise at least one of incident-angle dependence with respect to two-polarized-light phase difference and incident-angle dependence with respect to transmittance.

6. The method according to claim 1, wherein all of transparent members included in the projection optics are composed of an amorphous material.
